(19) United States
(12) Patent Application Publication
(10) Pub. No.: US 2024/0177291 A1
(43) Pub. Date: May 30, 2024

(54) METHOD FOR DETECTING SURFACE FLATNESS OF PRECAST BEAM BASED ON THREE-DIMENSIONAL POINT CLOUD MODEL

(71) Applicant: SOUTHEAST UNIVERSITY, Nanjing (CN)

(72) Inventors: Wen XIONG, Nanjing (CN); Chang XU, Nanjing (CN); Yanjie ZHU, Nanjing (CN)

(21) Appl. No.: 17/785,909

(22) PCT Filed: Nov. 15, 2021
(86) PCT No.: PCT/CN2021/130515

§ 371 Date: Jun. 16, 2022

(30) Foreign Application Priority Data
Oct. 13, 2021 (CN) 202111200770.7

(51) Int. Cl. G06T 7/00; G06T 3/60

(52) U.S. Cl. CPC G06T 7/0006; G06T 3/60; G06T 2207/10028; G06T 2207/30132

(57) ABSTRACT

The present invention discloses a method for detecting surface flatness of a precast beam based on a three-dimensional point cloud model, including the following steps: (1) performing, according to a specific geometry of a three-dimensional point cloud model of a target component in a three-dimensional coordinate system, coarse calibration and fine calibration on the model sequentially to determine a spatial rotation matrix and perform point cloud coordinate calibration; (2) determining normal vectors at positions of points of the three-dimensional point cloud model of the component according to a principal component analysis method and a K-nearest-neighbor principle, so that a to-be-detected surface is segmented and extracted by defining a normal vector direction and a coordinate interval; and (3) iteratively searching for an optimal reference plane according to a form relationship between the to-be-detected surface and the three-dimensional coordinate system and calculating flatness of the surface.

### TECHNICAL FIELD

The present invention relates to the field of detecting manufacturing quality of precast beams in bridge engineering, and specifically, to a method for detecting surface flatness of a precast beam based on a three-dimensional point cloud model.

### BACKGROUND

As an important evaluation index for detecting the manufacturing quality of precast beams, flatness reflects the aesthetic effect of construction and has sonic impact on the mechanical properties of the precast beams during service. Flatness that fails to meet specifications represents unreliable manufacturing quality of the precast beams to some extent. Currently, in the methods for detecting the flatness of precast beam in practical projects, contact measurement methods such as feeler gauges and profilometers are usually used. Such methods have low detection efficiency and insufficient accuracy and produce detection results that are not easy to manage digitally. A three-dimensional point cloud model is a set of massive points that contain properties of a target surface. The spatial form of an object surface is reflected based on the three-dimensional coordinates of points. Surface feature information of a precast component is acquired by using a three-dimensional laser scanner. Compared with the conventional detection methods, the three-dimensional point cloud model has advantages such as a non-contact type, a high sampling rate, and a high degree of automation. However, based on the point cloud model that contains information data of massive three-dimensional coordinates, how to quickly extract a target surface from the entire model, how to accurately detect the flatness of the surface, and how to implement integration into automatic calculation steps need to be solved urgently.

### SUMMARY

Objectives of the present invention: for a precast beam with a relatively regular geometric shape, a method for detecting surface flatness based on a three-dimensional point cloud model is provided, which is easy to be implemented by programming, and improves the calculation efficiency and the degree of automation compared with the conventional detection methods.

Technical solutions: a method for detecting surface flatness of a precast beam based on a three-dimensional point cloud model is provided, and includes the following steps:
(1) performing, according to a specific geometry of a three-dimensional point cloud model of a target component in a three-dimensional coordinate system, coarse calibration and fine calibration on the model sequentially to determine a spatial rotation matrix and perform point cloud coordinate calibration;
(2) determining normal vectors at positions of points of the three-dimensional point cloud model of the component according to a principal component analysis method and a K-nearest-neighbor principle, so that a to-be-detected surface is segmented and extracted by defining a normal vector direction and a coordinate interval; and
(3) iteratively searching for an optimal reference plane according to a form relationship between the to-be-detected surface and the three-dimensional coordinate system and calculating flatness of the surface.

Preferably, step (1), step (2), and step (3) all need to satisfy constraint conditions: a geometric shape of a precast beam is regular, a placement position of the precast beam is horizontal, an origin of the three-dimensional coordinate system is set at a centroid of the point cloud model, and directions of an X-axis, a Y-axis, and a Z-axis of the three-dimensional coordinate system are respectively parallel to directions of a beam width, a beam length, and a beam height of the component.

Preferably, step (1) specifically includes the following steps:
1.1 setting, for a three-dimensional point cloud model Pt₀ of the precast beam, an origin O of an original coordinate system X₀Y₀Z₀ at a centroid of the three-dimensional point cloud model:

$${Pt}_{c} = [ \begin{matrix}{x}_{1} - {μ}_{X} & {y}_{1} - {μ}_{Y} & {z}_{1} - {μ}_{Z} \\ {x}_{2} - {μ}_{X} & {y}_{2} - {μ}_{Y} & {z}_{2} - {μ}_{Z} \\ & ⋮ & \\ {x}_{n} - {μ}_{X} & {y}_{n} - {μ}_{Y} & {z}_{n} - {μ}_{Z}\end{matrix} ] ,$$

where Pt_{c} is a centralized three-dimensional point cloud model; x₁ , . . . xₙ are coordinate values of points X₀ in Pt₀, y₁ . . . yₙ are coordinate values of Y₀, and z₁ . . . zₙ are coordinate values of Z₀; and μ_{X} is an average value of the coordinate values of the points X₀ in Pt₀, μ_{Y} is an average value of the coordinate values of original Y₀, and μ_{Z} is an average value of the coordinate values of original Z₀;
1.2 determining, for the precast beam placed horizontally, that a positive direction of an initial Z₁ coordinate axis is an opposite direction of gravity and is parallel to a direction of the beam height, making a projection of the three-dimensional point cloud model Pt_{c} onto a plane X₀OY₀, performing a principal component analysis on the projection to first decentralize a projected point cloud according to a principle of the principal component analysis, calculate a covariance matrix of the decentralized point cloud, and perform singular value decomposition on the covariance matrix to obtain a group of eigenvalues and an eigenvector uniquely corresponding to each eigenvalue, where an eigenvector corresponding to the largest eigenvalue is a first principal component, and an eigenvector corresponding to the second largest eigenvalue is a second principal component; and defining a direction of a Y₁ coordinate axis as a direction of the first principal component, and defining a direction of an X₁ coordinate axis as a direction of the second principal component, to complete calibration of an initial coordinate system X₁Y₁Z₁, that is, coarse calibration of coordinates of the three-dimensional point cloud model; and
1.3 respectively making slices at appropriate positions capable of reflecting features of the beam width, the beam length, and the beam height of the component, where thicknesses of the slices are twice a point cloud density; making a projection of points contained in the slices to a slice plane and performing the principal component analysis, fitting the projection to a straight line, and comparing angles between the projected straight line and two coordinate axes; and defining a direction of a coordinate axis with a smaller angle with the projected straight line as the direction of the first principal component according to the principle of the principal component analysis, and defining a direction of an other coordinate axis in the slice plane as the direction of the second principal component, to complete calibration of a final coordinate system XYZ, that is, fine calibration of the coordinates of the three-dimensional point cloud model after the steps are completed for all the directions of the beam width, the beam length, and the beam height; and
calculating, according to an angle between the final coordinate system XYZ and the initial coordinate system X₁Y₁Z₁, rotation matrices Rₓ, R_{y}, and R_{z} corresponding to the point cloud that changes from the initial coordinate system X₁Y₁Z₁ to the final coordinate system XYZ, where if a rotation direction of rotating from the initial coordinate system X₁Y₁Z₁ to the final coordinate system XYZ is counterclockwise rotation, the obtained rotation matrices Rₓ, R_{y} and R_{z} are respectively:

$${R}_{x} = [ \begin{matrix}1 & 0 & 0 \\ 0 & cos α & - sin α \\ 0 & sin α & cos α\end{matrix} ] ,$$

$${R}_{y} = [ \begin{matrix}cos β & 0 & sin β \\ 0 & 1 & 0 \\ - sin β & 0 & cos β\end{matrix} ] , and$$

$${R}_{z} = [ \begin{matrix}cos γ & - sin γ & 0 \\ sin γ & cos γ & 0 \\ 0 & 0 & 1\end{matrix} ] ,$$

and
if the rotation direction is clockwise rotation, the obtained rotation matrices Rₓ, R_{y}, and R_{z} are respectively:

$${R}_{x} = [ \begin{matrix}1 & 0 & 0 \\ 0 & cos α & sin α \\ 0 & - sin α & cos α\end{matrix} ] ,$$

$${R}_{y} = [ \begin{matrix}cos β & 0 & - sin β \\ 0 & 1 & 0 \\ sin β & 0 & cos β\end{matrix} ] , and$$

$${R}_{z} = [ \begin{matrix}cos γ & sin γ & 0 \\ - sin γ & cos γ & 0 \\ 0 & 0 & 1\end{matrix} ] ,$$

where α is an angle between a coordinate system Y₁OZ₁ and a coordinate system YOZ; β is an angle between a coordinate system X₁OZ₁ and a coordinate system XOZ; and γ is an angle between a coordinate system X₁OY₁ and a coordinate system XOY; and obtaining a spatial rotation matrix R=Rₓ·R_{y}·R_{z} according to Rₓ, R_{y}, and R_{z} to implement point cloud coordinate calibration:

Pt=R·Pt_{c}.
where Pt_{c} is a centralized three-dimensional point cloud model, and Pt is a three-dimensional point cloud model after coordinate calibration.

Preferably, step (2) specifically includes the following steps:
2.1 selecting, for an i^{th} point pᵢ(xᵢ, yᵢ, zᵢ) in the three-dimensional point cloud model Pt, K nearest neighbor points according to the K-nearest-neighbor principle:

Pᵢ^{K}={pᵢ¹,pᵢ² . . . pᵢ^{K}|i∈{1,2 . . . N},K∈Z},
where N is the number of points in the three-dimensional point cloud model Pt, Pᵢ^{K} is a set of K nearest neighbor points of a point pᵢ, and pᵢ^{K} is a k^{th} neighbor point; and
sequentially performing decentralization, covariance matrix calculation, and singular value decomposition on Pᵢ^{K} according to the principle of the principal component analysis, defining a normal vector \vec{n₁} at a point pᵢ(xᵢ, yᵢ, zᵢ) as an eigenvector corresponding to a minimum eigenvalue, and specifying that a direction of the normal vector \vec{n₁} indicates a positive direction of a coordinate axis;
2.2 rotating a to-be-detected surface A that requires surface flatness detection in the precast beam to be parallel to a coordinate plane B:

A∥B,
where the coordinate plane B is any plane of XOY, XOZ, and YOZ; setting a reference vector \vec{nᵣ} as a unit vector perpendicular to the coordinate plane B, and calculating angles between normal vectors at points in the three-dimensional point cloud model Pt and the reference vector based on a vector angle formula, where an angle θᵢ between a normal vector \vec{nᵢ} at the i^{th} point pᵢ(xᵢ, yᵢ, zᵢ) in the three-dimensional point cloud model Pt and the reference vector \vec{nᵣ} is:

$${θ}_{i} = arccos ( \frac{\vec{{n}_{i}} \cdot \vec{{n}_{r}}}{\vert \vec{{n}_{i}} \vert \vert \vec{{n}_{r}} \vert} ) ;$$

setting an angle threshold θₛ as |θₛ|≤5°, where if a constraint condition θᵢ≤θₛ is satisfied during calculation, that is, θᵢ is not greater than the angle threshold θₛ, the point pᵢ(xᵢ, yᵢ, zᵢ) is a point forming the to-be-detected surface A, and the point is extracted into a set A₁; making, for points in the set A₁, a histogram by taking coordinate values of the points on a coordinate axis perpendicular to the to-be-detected surface A; and extracting points contained in an interval with a maximum frequency number into a set A₂; and
2.3 selecting, for an h^{th} point pₕ(xₕ, yₕ, zₕ) in the set A₂, K nearest neighbor points around the point to form a set Pₕ^{K} according to the K-nearest-neighbor principle; defining a point distance dₕ of the point pₕ as an average value of distances between the point and points in the set Pₕ^{K}, and calculating an average value d̅ and a standard deviation σ of point distances in the set A₂ if a result is a Gaussian distribution:

$$\overline{d} = \frac{1}{{N}_{{A}_{2}}} {\sum }_{h = 1}^{{N}_{{A}_{2}}} {d}_{h} , σ = \sqrt{\frac{1}{{N}_{{A}_{2}}} {\sum }_{h = 1}^{{N}_{{A}_{2}}} {( {d}_{h} - \overline{d} )}^{2}} , h ∈ \{ 1 , 2 … {N}_{{A}_{2}} \} ,$$

where N_{A}_{₂} is the number of points in the set A₂; and setting d̅+2σ as a distance threshold, where if a constraint condition: dₕ≤d̅+2σ is satisfied during calculation, that is, the point distance is not greater than the distance threshold, the point pₕ(xₕ, yₕ, zₕ) is a point forming the to-be-detected surface, and is extracted into the to-be-detected surface A.

Preferably, step (3) specifically includes the following steps:
3.1 because the to-be-detected surface A is formed by three-dimensional coordinate points and has a particular thickness, making, by passing through a point nearest to the coordinate plane B in the to-be-detected surface A, a reference plane RP₁ parallel to the coordinate plane B, the reference plane RP₁ being a₁x+b₁y+c₁z+d₁=0; and making, by passing through a point farthest from the coordinate plane B in the to-be-detected surface A, a reference plane RPₙ parallel to the coordinate plane B, the reference plane RPₙ being aₙx+bₙy+cₙz+dₙ=0, where a₁, b₁, c₁, d₁, aₙ, bₙ, cₙ, and dₙ are coefficients;
setting an iteration distance t as a point cloud density in the to-be-detected surface A, gradually translating the reference plane from RP₁ to RPₙ by an increment of t, and calculating distances between points in the to-be-detected surface A and reference planes at each moving moment, where a Euclidean distance rⱼ between a j^{th} point pⱼ(xⱼ, yⱼ, zⱼ) in the to-be-detected surface A and an m^{th} reference plane RPₘ is:

$${r}_{j} = \vert \frac{{a}_{m} {x}_{j} + {b}_{m} {y}_{j} + {c}_{m} {z}_{j} + {d}_{m}}{\sqrt{{a}_{m}^{2} + {b}_{m}^{2} + {c}_{m}^{2}}} \vert , j ∈ \{ 1 , 2 … {N}_{A} \} , m ∈ \{ 1 , 2 … {N}_{n} \} ,$$

where N_{A} is the number of points in the to-be-detected surface A, Nₙ is the number of reference planes, an expression of the reference plane RPₘ is aₘx+bₘy+cₘz+dₘ=0, and aₘ, bₘ, cₘ, and dₘ are coefficients; and defining, according to a least absolute deviation method, an optimal reference plane RP_{A} as a corresponding reference plane when a sum of rⱼ of the points in the to-be-detected surface A is minimal:

$${RP}_{A} ( {r}_{j} ) = argmin {\sum }_{j = 1}^{{N}_{A}} {r}_{j} ,$$

where an expression of the optimal reference plane RP_{A} is a_{A}x+b_{A}y+c_{A}z+d_{A}=0, and a_{A}, b_{A}, c_{A}, and d_{A} are coefficients; and
3.2 defining, for the j^{th} point pⱼ(xⱼ, yⱼ, zⱼ) in the to-be-detected surface A, surface flatness fⱼ at the point as a Euclidean distance between the point pⱼ and the optimal reference plane RP_{A}:

$${f}_{j} = \vert \frac{{a}_{A} {x}_{j} + {b}_{A} {y}_{j} + {c}_{A} {z}_{j} + {d}_{A}}{\sqrt{{a}_{A}^{2} + {b}_{A}^{2} + {c}_{A}^{2}}} \vert , j ∈ \{ 1 , 2 … {N}_{A} \} ;$$

obtaining a flatness distribution map of the to-be-detected surface A through marking with different colors according to a value of fⱼ, to complete detection of surface flatness of the precast beam.

Beneficial effects: Compared with the existing technology, the technical solution of the present invention has the following beneficial technical effects:

The present invention implements quick and accurate detection of flatness of a precast beam by performing coordinate calibration, target surface segmentation, and determination of an optimal reference plane on a three-dimensional point cloud model of the precast beam, which is beneficial to improving the calculation efficiency and the degree of automation. Avoiding the problem that the conventional contact measurement is prone to errors and results of the conventional contact measurement are less integrated, thereby saving calculation time and improving the degree of digital integration of detection results.

### BRIEF DESCRIPTION OF THE DRAWINGS

FIG. 1 is a flowchart of a method for detecting surface flatness of a precast beam based on a three-dimensional point cloud model according to the present invention;

FIG. 2 is a schematic diagram of implementing fine calibration of coordinate axes according to slice features;

FIG. 3 is a schematic diagram of a normal vector nᵢ at an i^{th} point pᵢ;

FIG. 4 is a schematic diagram of a histogram of a surface feature; and

FIG. 5 is a schematic diagram of a process of searching for an optimal reference plane.

### DETAILED DESCRIPTION

The technical solution of the present invention is further described below with reference to the drawings and specific embodiments.

The present invention needs to satisfy the following constraint conditions:
(1) A precast beam has a regular geometric shape. Generally, shapes of precast beams are regular basic patterns, mainly a rectangle. an I-shaped figure, etc. The present invention describes the specific implementation method by taking a cuboid beam with a square cross-section as an example.
(2) A placement position of the precast beam is basically horizontal, that is, there is a relatively small deviation between a direction of a Z-coordinate axis of a three-dimensional point cloud model and a direction of a beam height, which facilitates implementation of coordinate calibration.
(3) An origin of a three-dimensional coordinate system is set at a centroid of the three-dimensional point cloud model, a direction of an X-coordinate axis is parallel to a direction of a beam width, a direction of a Y-coordinate axis is parallel to a direction of a beam length, and the direction of the Z-coordinate axis is an opposite direction of gravity and is parallel to the direction of the beam height. For a regular precast beam model, the three-dimensional coordinate system is calibrated according to geometric features, making calculation and programming more convenient.

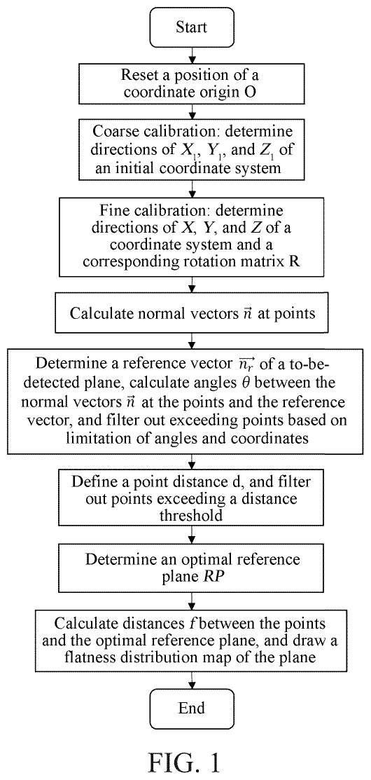

As shown in FIG. 1, a method for detecting surface flatness of a precast beam based on a three-dimensional point cloud model in the present invention mainly includes the following steps:
(1) performing, according to a specific geometry of a three-dimensional point cloud model of a target component in a three-dimensional coordinate system, coarse calibration and fine calibration on the model sequentially to determine a spatial rotation matrix and perform point cloud coordinate calibration;
(2) determining normal vectors at positions of points of the three-dimensional point cloud model of the component according to a principal component analysis method and a K-nearest-neighbor principle, so that a to-be-detected surface is segmented and extracted by defining a normal vector direction and a coordinate interval; and
(3) iteratively searching for an optimal reference plane according to a form relationship between the to-be-detected surface and the three-dimensional coordinate system and calculating flatness of the surface.

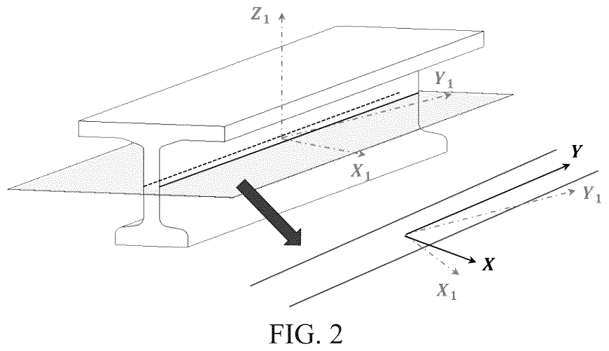

In this embodiment, step 1 specifically includes the following steps.
1.1 For a three-dimensional point cloud model Pt₀ of a precast beam, an origin O of an original coordinate system X₀Y₀Z₀ is set at a centroid of the three-dimensional point cloud model:

$${Pt}_{c} = [ \begin{matrix}{x}_{1} - {μ}_{X} & {y}_{1} - {μ}_{Y} & {z}_{1} - {μ}_{Z} \\ {x}_{2} - {μ}_{X} & {y}_{2} - {μ}_{Y} & {z}_{2} - {μ}_{Z} \\ & ⋮ & \\ {x}_{n} - {μ}_{X} & {y}_{n} - {μ}_{Y} & {z}_{n} - {μ}_{Z}\end{matrix} ] ,$$

where Pt_{c} is a centralized three-dimensional point cloud model; x₁ . . . xₙ are coordinate values of points X₀ in Pt₀, y₁ . . . yₙ are coordinate values of Y₀, and z₁ . . . zₙ are coordinate values of Z₀; and μ_{X} is an average value of the coordinate values of the points X₀ in Pt₀, μ_{Y} is an average value of the coordinate values of original Y₀, and μ_{Z} is an average value of the coordinate values of original Z₀; the algorithm of the present invention mainly targets a precast beam with a regular geometric shape, and an origin of a coordinate axis is set at a position of a centroid of the model, which can effectively simplify calculation and improve the efficiency.
1.2 The algorithm of the present invention mainly targets the precast beam placed horizontally. Therefore, it may be approximately determined that a positive direction of an initial Z₁ coordinate axis is the opposite direction of gravity and is approximately parallel to the direction of the beam height. A projection of the three-dimensional point cloud model Pt_{c} is made on a plane X₀OY₀, and a principal component analysis is performed on the projection. A projected point cloud is first decentralized according to a principle of the principal component analysis, a covariance matrix of the decentralized point cloud is calculated, and singular value decomposition is performed on the covariance matrix to obtain a group of eigenvalues and an eigenvector uniquely corresponding to each eigenvalue, where an eigenvector corresponding to the largest eigenvalue is a first principal component, and an eigenvector corresponding to the second largest eigenvalue is a second principal component. A direction of a Y₁ coordinate axis is defined as a direction of the first principal component, and a direction of an X₁ coordinate axis is defined as a direction of the second principal component, to complete calibration of an initial coordinate system X₁Y₁Z₁, that is, coarse calibration of coordinates of the three-dimensional point cloud model.
1.3 Referring to FIG. 2, slices are respectively made at appropriate positions capable of reflecting features of the beam width, the beam length, and the beam height of the component, where thicknesses of the slices are twice a point cloud density, and the obtained slices may have the following characteristics: a. the slices have a sufficient length; and b. It should be ensured as much as possible that points contained in the slices is clear and continuous. Short slices or insufficient continuity may easily lead to identification errors during the principal component analysis.

A projection of the points contained in the slices is made to a slice plane, the principal component analysis is performed, and the projection of the points may be approximated as a straight line. By comparing angles between the projected straight line and two coordinate axes according to the principle of the principal component analysis, a direction of a coordinate axis which has a smaller angle with the projected straight line is defined as the direction of the first principal component, and a direction of an other coordinate axis in the slice plane is defined as the direction of the second principal component. After the steps for the directions of the beam width, the beam length, and the beam height are completed, calibration of a final coordinate system XYZ, that is, fine calibration of the coordinates of the three-dimensional point cloud model, is completed.

According to an angle between the final coordinate system XYZ and the initial coordinate system X₁Y₁Z₁, rotation matrices Rₓ, R_{y}, and R_{z} corresponding to the point cloud that changes from the initial coordinate system X₁Y₁Z₁ to the final coordinate system XYZ are calculated. If a rotation direction of rotating from the initial coordinate system X₁Y₁Z₁ to the final coordinate system XYZ is counterclockwise rotation, the obtained rotation matrices Rₓ, R_{y}, and R_{z} are respectively:

$${R}_{x} = [ \begin{matrix}1 & 0 & 0 \\ 0 & cos α & - sin α \\ 0 & sin α & cos α\end{matrix} ] ,$$

$${R}_{y} = [ \begin{matrix}cos β & 0 & sin β \\ 0 & 1 & 0 \\ - sin β & 0 & cos β\end{matrix} ] , and$$

$${R}_{z} = [ \begin{matrix}cos γ & - sin γ & 0 \\ sin γ & cos γ & 0 \\ 0 & 0 & 1\end{matrix} ] ,$$

and
if the rotation direction is clockwise rotation, the obtained rotation matrices Rₓ, R_{y}, and R_{z} are respectively:

$${R}_{x} = [ \begin{matrix}1 & 0 & 0 \\ 0 & cos α & sin α \\ 0 & - sin α & cos α\end{matrix} ] ,$$

$${R}_{y} = [ \begin{matrix}cos β & 0 & - sin β \\ 0 & 1 & 0 \\ sin β & 0 & cos β\end{matrix} ] , and$$

$${R}_{z} = [ \begin{matrix}cos γ & sin γ & 0 \\ - sin γ & cos γ & 0 \\ 0 & 0 & 1\end{matrix} ] ,$$

where α is an angle between a coordinate system Y₁OZ₁ and a coordinate system YOZ: β is an angle between a coordinate system X₁OZ₁ and a coordinate system XOZ; and γ is an angle between a coordinate system X₁OY₁ and a coordinate system XOY.

In summary, a spatial rotation matrix R=Rₓ·R_{y}·R_{z} is obtained, to implement point cloud coordinate calibration:

Pt=R·Pt_{c},
where Pt_{c} is a centralized three-dimensional point cloud model, and Pt is a three-dimensional point cloud model after coordinate calibration.

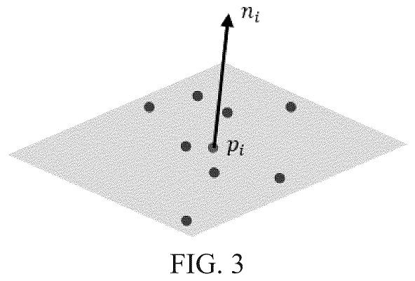

In this embodiment, step 2 specifically includes the following steps.
2. 1 Referring to FIG. 3, for an i^{th} point pᵢ(xᵢ, yᵢ, zᵢ) in a three-dimensional point cloud model Pt, K nearest neighbor points are selected according to the K-nearest-neighbor principle:

Pᵢ^{K}={pᵢ¹,pᵢ² . . . pᵢ^{K}|i∈{1,2 . . . N},K∈Z},
where N is the number of points in the three-dimensional point cloud model Pt, Pᵢ^{K} is a set of K nearest neighbor points of a point pᵢ, and pᵢ^{K} is neighbor points.

Decentralization, covariance matrix calculation, and singular value decomposition are sequentially performed on Pᵢ^{K} according to the principle of the principal component analysis, a normal vector \vec{n₁} at a point pᵢ(xᵢ, yᵢ, zᵢ) is defined as an eigenvector corresponding to a minimum eigenvalue, and it is specified that a direction of the normal vector \vec{n₁} indicates a positive direction of a coordinate axis. The principle is to fit a plane based on the K neighbor points of the point pᵢ(xᵢ, yᵢ, zᵢ), and convert calculation of the normal vector at the point pᵢ into calculation of a normal vector of the above fitted plane.
2.2 A to-be-detected surface A that requires surface flatness detection in the precast beam is rotated to be parallel to a coordinate plane B:

A∥B.
where the coordinate plane B is any plane of XOY, XOZ, and YOZ. A reference vector \vec{nᵣ} is set as a unit vector perpendicular to the coordinate plane B, and angles between normal vectors at points in the three-dimensional point cloud model Pt and the reference vector are calculated based on a vector angle formula, where an angle θᵢ between a normal vector \vec{n₁} at the i^{th} point pᵢ(xᵢ, yᵢ, zᵢ) in the three-dimensional point cloud model Pt and the reference vector is:

$${θ}_{i} = arccos ( \frac{\vec{{n}_{i}} \cdot \vec{{n}_{r}}}{\vert \vec{{n}_{i}} \vert \vert \vec{{n}_{r}} \vert} ) .$$

An angle threshold θₛ is set as |θₛ|≤5°. If a constraint condition θᵢ≤θₛ is satisfied during calculation, that is, θᵢ is not greater than the angle threshold θₛ, the point pᵢ(xᵢ, yᵢ, zᵢ) is a point forming the to-be-detected surface A, and the point is extracted into a set A₁.

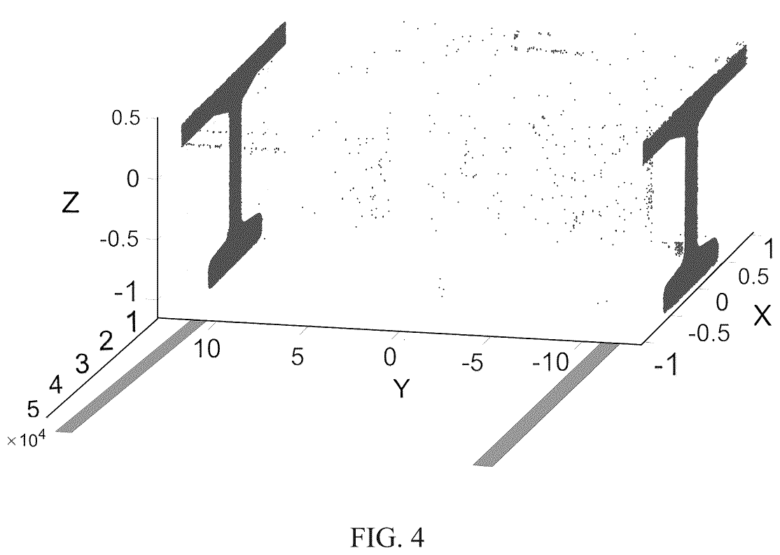

Referring to FIG. 4, for points in the set A₁, a histogram is made by taking coordinate values of the points on a coordinate axis perpendicular to the to-be-detected surface A, and points included in an interval with a maximum frequency number are extracted into a set A₂.
2.3 For an h^{th} point pₕ(xₕ, yₕ, zₕ) in the set A₂, K nearest neighbor points around the point are selected to form a set Pₕ^{K} according to the K-nearest-neighbor principle. A point distance dₕ of the point pₕ is defined as an average value of distances between the point and points in the set Pₕ^{K}, and an average value d̅ and a standard deviation σ of point distances in the set A₂ are calculated if a result is a Gaussian distribution:

$$\overline{d} = \frac{1}{{N}_{{A}_{2}}} {\sum }_{h = 1}^{{N}_{{A}_{2}}} {d}_{h} , σ = \sqrt{\frac{1}{{N}_{{A}_{2}}} {\sum }_{h = 1}^{{N}_{{A}_{2}}} {( {d}_{h} - \overline{d} )}^{2}} , h ∈ \{ 1 , 2 … {N}_{{A}_{2}} \} ,$$

where N_{A}_{₂} is the number of points in the set A₂. d̅+2σ is set as a distance threshold, where if a constraint condition: dₕ≤d̅+2σ is satisfied during calculation, that is, the point distance is not greater than the distance threshold, the point pₕ(xₕ, yₕ, zₕ) is a point forming the to-be-detected surface, and is extracted into the to-be-detected surface A.

In this embodiment, step 3 specifically includes the following steps.
3.1 Because the to-be-detected surface A is formed by three-dimensional coordinate points and has a particular thickness, a reference plane RP1(a₁x+b₁y+c₁z+d₁=0) parallel to the coordinate plane B is made by passing through a point nearest to the coordinate plane B in the to-be-detected surface A; and a reference plane RPₙ(aₙx+bₙy+cₙz+dₙ=0) parallel to the coordinate plane B is made by passing through a point farthest from the coordinate plane B in the to-be-detected surface A.

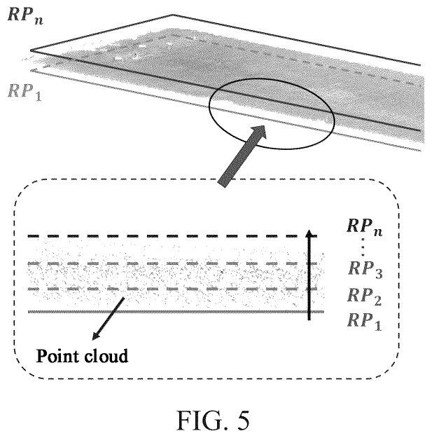

Referring to FIG. 5, an iteration distance t is set as a point cloud density in the to-be-detected surface A. the reference plane is gradually translated from RP₁ to RPₙ by an increment of t, and distances between points in the to-be-detected surface A and reference planes are calculated at each moving moment, where a Euclidean distance rⱼ between a j^{th} point pⱼ(xⱼ, yⱼ, zⱼ) in the to-be-detected surface A and an m^{th} reference plane RPₘ(aₘx+bₘy+cₘz+dₘ=0) is:

$${r}_{j} = \vert \frac{{a}_{m} {x}_{j} + {b}_{m} {y}_{j} + {c}_{m} {z}_{j} + {d}_{m}}{\sqrt{{a}_{m}^{2} + {b}_{m}^{2} + {c}_{m}^{2}}} \vert , j ∈ \{ 1 , 2 … {N}_{A} \} , m ∈ \{ 1 , 2 … {N}_{n} \} ,$$

where N_{A} is the number of points in the to-be-detected surface A, and Nₙ is the number of reference planes.

According to a least absolute deviation method, an optimal reference plane RP_{A}(a_{A}x+b_{A}y+c_{A}z+d_{A}=0) is defined as a corresponding reference plane when a sum of rⱼ of the points in the to-be-detected surface A is minimal:

$${RP}_{A} ( {r}_{j} ) = argmin {\sum }_{j = 1}^{{N}_{A}} {r}_{j} .$$

3.2 For the j^{th} point pⱼ(xⱼ, yⱼ, zⱼ) in the to-be-detected surface A, surface flatness fⱼ at the point is defined as a Euclidean distance between the point pⱼ and the optimal reference plane RP_{A}(a_{A}x+b_{A}y+c_{A}z+d_{A}=0):

$${f}_{j} = \vert \frac{{a}_{A} {x}_{j} + {b}_{A} {y}_{j} + {c}_{A} {z}_{j} + {d}_{A}}{\sqrt{{a}_{A}^{2} + {b}_{A}^{2} + {c}_{A}^{2}}} \vert , j ∈ \{ 1 , 2 … {N}_{A} \} .$$

A flatness distribution map of the to-be-detected surface A may be obtained through marking with different colors according to a value of fⱼ, to complete detection of surface flatness of the precast beam.

Because the algorithm is established based on a plurality of constraint conditions, the algorithm is not suitable for detection of surface flatness of all precast beams. However, for most of the commonly used types of precast beams in practical engineering, the algorithm can greatly improve the calculation efficiency and the automation degree of the flatness detection link compared with the existing conventional detection methods.

The following further describes the technical solutions of the present invention with reference to specific cases. The case calculation mainly performs algorithm programming based on MATLAB, to obtain calculation results.

The studied precast beam is a cuboid beam with a square cross-section, a beam length is 10 m, a beam width is 2 m, a beam height is 2 m, and a point cloud density is 1/cm². An area that has a width of 0.1 m and a length of 0.2 m and is 0.003 m above an original plane is preset at an end of a top surface of the beam, to simulate the situation that the precast beam is not flat. Rotation matrices are applied in advance:

$${R}_{x} = [ \begin{matrix}1 & 0 & 0 \\ 0 & 1 & 0.0015 \\ 0 & - 0.0015 & 1\end{matrix} ] ,$$

$${R}_{y} = [ \begin{matrix}1 & 0 & - 0.0042 \\ 0 & 1 & 0 \\ 0.0042 & 0 & 1\end{matrix} ] , and$$

$${R}_{z} = [ \begin{matrix}1 & 0.0029 & 0 \\ - 0.0029 & 1 & 0 \\ 0 & 0 & 1\end{matrix} ] .$$

1. Decentralization is performed on a three-dimensional point cloud model of the precast beam, and coarse calibration is performed according to an initial form of the three-dimensional point cloud model, to obtain a rotation matrix

$${Rot}_{z 1} = [ \begin{matrix}1 & - 0.0017 & 0 \\ 0.0017 & 1 & 0 \\ 0 & 0 & 1\end{matrix} ] .$$

Subsequently, according to step 1.3, fine calibration is respectively performed on directions of three coordinate axes in the three-dimensional point cloud model, to obtain rotation matrices:

$${Rot}_{x} = [ \begin{matrix}1 & 0 & 0 \\ 0 & 1 & - 0.0015 \\ 0 & 0.0015 & 1\end{matrix} ] ,$$

$${Rot}_{y} = [ \begin{matrix}1 & 0 & 0.0042 \\ 0 & 1 & 0 \\ - 0.0042 & 0 & 1\end{matrix} ] , and$$

$${Rot}_{z 2} = [ \begin{matrix}1 & - 0.0012 & 0 \\ 0.0012 & 1 & 0 \\ 0 & 0 & 1\end{matrix} ] .$$

The rotation matrices are consistent with the preset rotation matrices.
2. According to step 2.1, normal vectors at points are calculated. To extract a point cloud contained in the top surface, a reference normal vector \vec{nᵣ}=(0,0,1) is set, and angles between the normal vectors at the points and the reference normal vector are calculated. An angle threshold θₛ is set to be greater than or equal to 5°, it is sequentially determined whether the normal vectors at the points satisfy a standard, and points that satisfy a determining condition θᵢ≤θₛ are extracted into a set A₂. A histogram is made with a width of 0.1 m by selecting z-coordinates of the points in the set A₂, and points corresponding to units that include more than 5000 three-dimensional points whose z-coordinates are greater than 0 are extracted. According to step 2.3, point distances, an average point distance, and a standard deviation of the extracted points are calculated, and points exceeding a distance threshold d̅+2σ are filtered out, to obtain a final point cloud of the top surface.
3. According to step 3.1, a reference plane z=min z is made, and is moved to z=max z by an increment of 0.0001 m. For each reference plane z=zᵢ, distances between the points and the reference plane are calculated. An optimal reference plane is finally determined as z=0.9991, and a distance between a non-flat part and the optimal reference plane is 0.003 m, and is consistent with the initial setting.

The present invention relates to a list of symbols and parameters as follows:

| | Centralized three- | | Original | | Initial |
|---|---|---|---|---|---|
| | dimensional point | | coordinate | | coordinate |
| Pt_{c} | cloud model | X₀Y₀Z₀ | system | X₁Y₁Z₁ | system |
| xᵢ | X-coordinate value of a | yᵢ | Y-coordinate value | zᵢ | Z-coordinate value |
| | point i | | of the point i | | of the point i |
| Rₓ | Rotation matrix around | R_{y} | Rotation matrix | R_{z} | Rotation matrix |
| | an X-axis | | around a Y-axis | | around a Z-axis |
| α | Angle between a | β | Angle between a | γ | Angle between a |
| | coordinate system | | coordinate system | | coordinate system |
| | Y₁OZ₁ and a | | X₁OZ₁ and a | | X₁OY₁ and a |
| | coordinate system | | coordinate system | | coordinate system |
| | YOZ | | XOZ | | XOY |
| K | The number of nearest | pᵢ | i^{th} three- | | |
| | neighbor points | | dimensional | | |
| | | | coordinate point | | |
| Pᵢ^{K} | Set of K nearest | pᵢ^{K} | Neighbor point | | |
| | neighbor points of the | | | | |
| | i^{th} pointp; | | | | |
| pᵢ^{j} | j^{th} neighbor point of pᵢ | p_{c} | Midpoint of K | A | To-be-detected |
| | | | neighbor points | | surface |
| \vec{nᵣ} | Reference vector | \vec{n₁} | Normal vector at an | θᵢ | angle between the |
| | | | i^{th} point | | normal vector ni |
| | | | | | and the reference |
| | | | | | vector |
| θₛ | Angle threshold | A₁ | Set of points at | A₂ | Set of points |
| | | | which normal | | whose coordinates |
| | | | vectors satisfy a | | are in a specified |
| | | | threshold | | range |
| dᵢ | Point distance | d̅ | Average value of | σ | Standard deviation |
| | | | point distances | | of the point |
| | | | | | distances |
| N | The number of points | N_{A} | The number of | N_{A}_{₂} | The number of |
| | in the three- | | points in a set A | | points in a set A₂ |
| | dimensional point | | | | |
| | cloud model | | | | |
| RP_{A} | Optimal reference | zᵣ | z-coordinate value | fᵢ | Surface flatness at |
| | plane of the surface A | | corresponding to a | | the point i |
| | | | reference plane | | |

The foregoing content further describes the present invention in detail with reference to only one specific embodiment, and it should not be considered that the present invention is limited to these descriptions. A person of ordinary skill in the art can further make simple deductions or replacements without departing from the concept of the present invention, and such deductions or replacements should all be considered as falling within the protection scope of the present invention.

What is claimed is:

1. A method for detecting surface flatness of a precast beam based on a three-dimensional point cloud model, comprising the following steps:
(1) performing, according to a specific geometry of a three-dimensional point cloud model of a target component in a three-dimensional coordinate system, coarse calibration and fine calibration on the model sequentially to determine a spatial rotation matrix and perform point cloud coordinate calibration;
(2) determining normal vectors at positions of points of the three-dimensional point cloud model of the component according to a principal component analysis method and a K-nearest-neighbor principle, so that a to-be-detected surface is segmented and extracted by defining a normal vector direction and a coordinate interval; and
(3) iteratively searching for an optimal reference plane according to a form relationship between the to-be-detected surface and the three-dimensional coordinate system and calculating flatness of the surface.

2. The method for detecting surface flatness of a precast beam based on a three-dimensional point cloud model according to claim 1, wherein step (1), step (2), and step (3) all need to satisfy constraint conditions: a geometric shape of a precast beam is regular, a placement position of the precast beam is horizontal, an origin of the three-dimensional coordinate system is set at a centroid of the point cloud model, and directions of an X-axis, a Y-axis, and a Z-axis of the three-dimensional coordinate system are respectively parallel to directions of a beam width, a beam length, and a beam height of the component.

3. The method for detecting surface flatness of a precast beam based on a three-dimensional point cloud model according to claim 1, wherein step (1) specifically comprises the following steps:
1.1 setting, for a three-dimensional point cloud model Pt₀ of the precast beam, an origin O of an original coordinate system X₀Y₀Z₀ at a centroid of the three-dimensional point cloud model:
$${Pt}_{c} = [ \begin{matrix}{x}_{1} - {μ}_{X} & {y}_{1} - {μ}_{Y} & {z}_{1} - {μ}_{Z} \\ {x}_{2} - {μ}_{X} & {y}_{1} - {μ}_{Y} & {z}_{1} - {μ}_{Z} \\ & ⋮ & \\ {x}_{n} - {μ}_{X} & {y}_{n} - {μ}_{Y} & {z}_{n} - {μ}_{Z}\end{matrix} ] ,$$
wherein Pt_{c} is a centralized three-dimensional point cloud model; x₁ . . . xₙ are coordinate values of points X₀ in Pt₀, y₁ . . . yₙ are coordinate values of Y₀, and z₁ . . . zₙ are coordinate values of Z₀; and μ_{X} is an average value of the coordinate values of the points X₀ in Pt₀, μ_{Y} is an average value of the coordinate values of original Y₀, and μ_{Z} is an average value of the coordinate values of original Z₀;
1.2 determining, for the precast beam placed horizontally, that a positive direction of an initial Z₁ coordinate axis is an opposite direction of gravity and is parallel to a direction of the beam height, making a projection of the three-dimensional point cloud model Pt_{c} onto a plane X₀OY₀, performing a principal component analysis on the projection to first decentralize a projected point cloud according to a principle of the principal component analysis, calculate a covariance matrix of the decentralized point cloud, and perform singular value decomposition on the covariance matrix to obtain a group of eigenvalues and an eigenvector uniquely corresponding to each eigenvalue, wherein an eigenvector corresponding to the largest eigenvalue is a first principal component, and an eigenvector corresponding to the second largest eigenvalue is a second principal component; and defining a direction of a Y₁ coordinate axis as a direction of the first principal component, and defining a direction of an X₁ coordinate axis as a direction of the second principal component, to complete calibration of an initial coordinate system X₁Y₁Z₁, that is, coarse calibration of coordinates of the three-dimensional point cloud model; and
1.3 respectively making slices at appropriate positions capable of reflecting features of the beam width. the beam length, and the beam height of the component, wherein thicknesses of the slices are twice a point cloud density; making a projection of points contained in the slices to a slice plane and performing the principal component analysis, fitting the projection to a straight line. and comparing angles between the projected straight line and two coordinate axes; and defining a direction of a coordinate axis with a smaller angle with the projected straight line as the direction of the first principal component according to the principle of the principal component analysis, and defining a direction of an other coordinate axis in the slice plane as the direction of the second principal component, to complete calibration of a final coordinate system XYZ, that is, fine calibration of the coordinates of the three-dimensional point cloud model after the steps are completed for all the directions of the beam width, the beam length, and the beam height; and
calculating, according to an angle between the final coordinate system XYZ and the initial coordinate system X₁Y₁Z₁, rotation matrices Rₓ, R_{y}, and R_{z} corresponding to the point cloud that changes from the initial coordinate system X₁Y₁Z₁ to the final coordinate system XYZ, wherein if a rotation direction of rotating from the initial coordinate system X₁Y₁Z₁ to the final coordinate system XYZ is counterclockwise rotation, the obtained rotation matrices Rₓ, R_{y}, and R_{z} are respectively:
$${R}_{x} = [ \begin{matrix}1 & 0 & 0 \\ 0 & cos α & - sin α \\ 0 & sin α & cos α\end{matrix} ] ,$$
$${R}_{y} = [ \begin{matrix}cos β & 0 & sin β \\ 0 & 1 & 0 \\ - sin β & 0 & cos β\end{matrix} ] , and$$
$${R}_{z} = [ \begin{matrix}cos γ & - sin γ & 0 \\ sin γ & cos γ & 0 \\ 0 & 0 & 1\end{matrix} ] ,$$
and
if the rotation direction is clockwise rotation, the obtained rotation matrices Rₓ, R_{y}, and R_{z} are respectively:
$${R}_{x} = [ \begin{matrix}1 & 0 & 0 \\ 0 & cos α & sin α \\ 0 & - sin α & cos α\end{matrix} ] ,$$
$${R}_{y} = [ \begin{matrix}cos β & 0 & - sin β \\ 0 & 1 & 0 \\ sin β & 0 & cos β\end{matrix} ] , and$$
$${R}_{z} = [ \begin{matrix}cos γ & sin γ & 0 \\ - sin γ & cos γ & 0 \\ 0 & 0 & 1\end{matrix} ] ,$$
wherein α is an angle between a coordinate system Y₁OZ₁ and a coordinate system YOZ; β is an angle between a coordinate system X₁OZ₁ and a coordinate system XOZ; and γ is an angle between a coordinate system X₁OY₁ and a coordinate system XOY; and obtaining a spatial rotation matrix R=Rₓ·R_{y}·R_{z} according to Rₓ, R_{y}, R_{z}, to implement point cloud coordinate calibration:
Pt=R·Pt_{c},
wherein Pt_{c} is a centralized three-dimensional point cloud model, and Pt is a three-dimensional point cloud model after coordinate calibration.

4. The method for detecting surface flatness of a precast beam based on a three-dimensional point cloud model according to claim 3, wherein step (2) specifically comprises the following steps:
2.1 selecting, for an i^{th} point pᵢ(xᵢ, yᵢ, zᵢ) in the three-dimensional point cloud model Pt, K nearest neighbor points according to the K-nearest-neighbor principle:
Pᵢ^{K}={pᵢ¹,pᵢ² . . . pᵢ^{K}|i∈{1,2 . . . N},K∈Z},
wherein N is the number of points in the three-dimensional point cloud model Pt, Pᵢ^{K} is a set of K nearest neighbor points of a point pᵢ, and pᵢ^{K} is a k^{th} neighbor point; and
sequentially performing decentralization, covariance matrix calculation, and singular value decomposition on Pᵢ^{K} according to the principle of the principal component analysis, defining a normal vector \vec{n₁} at a point pᵢ(xᵢ, yᵢ, zᵢ) as an eigenvector corresponding to a minimum eigenvalue, and specifying that a direction of the normal vector \vec{n₁} indicates a positive direction of a coordinate axis;
2.2 rotating a to-be-detected surface A that requires surface flatness detection in the precast beam to be parallel to a coordinate plane B:
A∥B,
wherein the coordinate plane B is any plane of XOY, XOZ, and YOZ;
setting a reference vector \vec{nᵣ} as a unit vector perpendicular to the coordinate plane B, and calculating angles between normal vectors at points in the three-dimensional point cloud model Pt and the reference vector based on a vector angle formula, wherein an angle θᵢ between a normal vector \vec{n₁} at the i^{th} point pᵢ(xᵢ, yᵢ, zᵢ) in the three-dimensional point cloud model Pt and the reference vector \vec{nᵣ} is:
$${θ}_{i} = arccos ( \frac{\vec{{n}_{i}} \cdot \vec{{n}_{r}}}{\vert \vec{{n}_{i}} \vert \vert \vec{{n}_{r}} \vert} ) ;$$
and
setting an angle threshold θₛ as |θₛ|≤5°, wherein if a constraint condition θᵢ≤θₛ is satisfied during calculation, that is, θᵢ is not greater than the angle threshold θₛ, the point pᵢ(xᵢ, yᵢ, zᵢ) is a point forming the to-be-detected surface A, and the point is extracted into a set A₁; making, for points in the set A₁, a histogram by taking coordinate values of the points on a coordinate axis perpendicular to the to-be-detected surface A; and extracting points contained in an interval with a maximum frequency number into a set A₂; and
2.3 selecting, for an h^{th} point pₕ(xₕ, yₕ, zₕ) in the set A₂, K nearest neighbor points around the point to form a set Pₕ^{K} according to the K-nearest-neighbor principle; defining a point distance dₕ of the point pₕ as an average value of distances between the point and points in the set Pₕ^{K}, and calculating an average value d̅ and a standard deviation σ of point distances in the set A₂ if a result is a Gaussian distribution:
$$\overline{d} = \frac{1}{{N}_{{A}_{2}}} {\sum }_{h = 1}^{{N}_{{A}_{2}}} {d}_{h} , σ = \sqrt{\frac{1}{{N}_{{A}_{2}}} {\sum }_{h = 1}^{{N}_{{A}_{2}}} {( {d}_{h} - \overline{d} )}^{2}} , h ∈ \{ 1 , 2 … {N}_{{A}_{2}} \} ,$$
wherein N_{A}_{₂} is the number of points in the set A₂; and setting d̅+2σ as a distance threshold, wherein if a constraint condition: dₕ≤d̅+2σ is satisfied during calculation, that is, the point distance is not greater than the distance threshold, the point pₕ(xₕ, yₕ, zₕ) is a point forming the to-be-detected surface, and is extracted into the to-be-detected surface A.

5. The method for detecting surface flatness of a precast beam based on a three-dimensional point cloud model according to claim 4, wherein step (3) specifically comprises the following steps:
3.1 because the to-be-detected surface A is formed by three-dimensional coordinate points and has a particular thickness, making, by passing through a point nearest to the coordinate plane B in the to-be-detected surface A, a reference plane RP₁ parallel to the coordinate plane B, the reference plane RP₁ being a₁x+b₁y+c₁z+d₁=0; and making, by passing through a point farthest from the coordinate plane B in the to-be-detected surface A, a reference plane RPₙ parallel to the coordinate plane B, the reference plane RPₙ being aₙx+bₙy+cₙz+dₙ=0, wherein a₁, b₁, c₁, d₁, aₙ, bₙ, cₙ, and dₙ are coefficients;
setting an iteration distance t as a point cloud density in the to-be-detected surface A, gradually translating the reference plane from RP₁ to RPₙ by an increment of t, and calculating distances between points in the to-be-detected surface A and reference planes at each moving moment, wherein a Euclidean distance rⱼ between a j^{th} point pⱼ(xⱼ, yⱼ, zⱼ) in the to-be-detected surface A and an m^{th} reference plane RPₘ is:
$${r}_{j} = \vert \frac{{a}_{m} {x}_{j} + {b}_{m} {y}_{j} + {c}_{m} {z}_{j} + {d}_{m}}{\sqrt{{a}_{m}^{2} + {b}_{m}^{2} + {c}_{m}^{2}}} \vert , j ∈ \{ 1 , 2 … {N}_{A} \} , m ∈ \{ 1 , 2 … {N}_{n} \} ,$$
wherein N_{A} is the number of points in the to-be-detected surface A, Nₙ is the number of reference planes, an expression of the reference plane RPₘ is aₘx+bₘy+cₘz+dₘ=0, and aₘ, bₘ, cₘ, and dₘ are coefficients; and defining, according to a least absolute deviation method, an optimal reference plane RP_{A} as a corresponding reference plane when a sum of rⱼ of the points in the to-be-detected surface A is minimal:
$${RP}_{A} ( {r}_{j} ) = argmin {\sum }_{j = 1}^{{N}_{A}} {r}_{j} ,$$
wherein an expression of the optimal reference plane RP_{A} is a_{A}x+b_{A}y+c_{A}z+d_{A}=0, and a_{A}, b_{A}, c_{A}, and d_{A} are coefficients; and
3.2 defining, for the j^{th} point pⱼ(xⱼ, yⱼ, zⱼ) in the to-be-detected surface A, surface flatness fⱼ at the point as a Euclidean distance between the point pⱼ and the optimal reference plane RP_{A}:
$${f}_{j} = \vert \frac{{a}_{A} {x}_{j} + {b}_{A} {y}_{j} + {c}_{A} {z}_{j} + {d}_{A}}{\sqrt{{a}_{A}^{2} + {b}_{A}^{2} + {c}_{A}^{2}}} \vert , j ∈ \{ 1 , 2 … {N}_{A} \} ;$$
and
obtaining a flatness distribution map of the to-be-detected surface A through marking with different colors according to a value of fⱼ, to complete detection of surface flatness of the precast beam.
